(19) United States
(12) Patent Application Publication
(10) Pub. No.: US 2013/0194803 A1
(43) Pub. Date: Aug. 1, 2013

(54) LIGHTING MODULE, ILLUMINATING DEVICE AND METHOD FOR FABRICATING THE LIGHTING MODULE

(71) Applicants: Xiaomian Chen, Shenzhen (CN); Hoitat Cheng, Hong Kong (CN); Yubao He, Shenzhen (CN); Tengzhi Qin, Shenzhen (CN)

(72) Inventors: Xiaomian Chen, Shenzhen (CN); Hoitat Cheng, Hong Kong (CN); Yubao He, Shenzhen (CN); Tengzhi Qin, Shenzhen (CN)

(73) Assignee: OSRAM GMBH, Muenchen (DE)

(21) Appl. No.: 13/821,580

(22) PCT Filed: Aug. 17, 2011
(86) PCT No.: PCT/EP2011/064146

§ 371 Date: Apr. 11, 2013

(30) Foreign Application Priority Data
Sep. 10, 2010 (CN) 201010281136.6

(51) Int. Cl. F21V 21/00

(52) U.S. Cl. CPC F21V 21/00
USPC 362/249.01; 29/428

(57) ABSTRACT

A lighting module for illuminating device may include at least one lighting component; at least one lighting component bracket bearing its corresponding lighting component; and one mounting trail, wherein each lighting component bracket is mounted onto the mounting trail and fixed onto a shell of the illuminating device by the mounting trail.

### TECHNICAL FIELD

The present invention relates to a lighting module for illuminating device and method for fabricating the same. In addition, the present invention also relates to an illuminating device which has the lighting module of the above type.

### BACKGROUND ART

The direct backlight illuminating device has been more and more widely used. Generally, the direct backlight illuminating device uses the LED module which can be designed as chain, plate or puzzle module. However, it is difficult to install the chain module in the light box of a big size because the lighting modules of the chain module should be connected together to form the chain module and to be installed in the light box, which will certainly prolong the installing time and increase the difficulty in installation. The plate module inevitably has the defect of having a high structure weight. And as to the type of puzzle module in the prior art, it also has the defect of having a high structure weight. Moreover, the modules of the above types can hardly meet the requirement of double-side light box, because the LED lighting components in the modules of the above types merely can be arranged on one side of the module. In order to meet the requirement of double-side lighting, at least two groups of modules should be simultaneously arranged to emit light to both sides, respectively, which will necessarily increase the weight of the whole system.

### SUMMARY OF THE INVENTION

Therefore, the objective of the present invention is to provide a lighting module for an illuminating device. The lighting module has a fishbone structure with a relatively light structure weight and can meet the requirement of double-side illumination without notably changing the structure weight; and the thickness of the whole lighting module is quite small.

The objective of the present invention is accomplished in the way as follow, namely, the lighting module has: at least one lighting component; at least one lighting component bracket bearing respective corresponding lighting component; and one mounting trail, wherein, each lighting component bracket is connected to the mounting trail and fixed onto the shell of the illuminating device by the mounting trail. The lighting module according to the present invention has a unique mounting trail, and all the lighting component brackets are mounted on the mounting trail, thereby, a fishbone structure is obtained. In this structure, all the material portions unrelated to the electrical connection and part-bearing are completely removed, which therefore greatly reduces the structure weight of the whole module.

In a preferred solution of the present invention, the mounting trail has a plurality of accommodating portions, and each lighting component bracket is mounted into its corresponding accommodating portion, such that each lighting component bracket can be stably accommodated into its corresponding accommodating portion.

In a preferred solution of the present invention, the mounting trail is fixed onto the shell of the illuminating device by end-caps provided at its both ends. The whole lighting module can be fixed onto the shell in such a simple manner, thereby, the mounting complexity is reduced.

In one specially preferred solution, each lighting component bracket is mounted into its corresponding accommodating portion by interference fit with the fastener such as push screw. Since the lighting component bracket is fixed into corresponding accommodating portion by the fastener, the lighting component bracket can be simply mounted and demounted according to the practical requirements, thereby to provide great application flexibility.

According to one solution of the present invention, the accommodating portions are provided on one same side of the mounting trail along the extending direction of the mounting trail. In such situation, the lighting component brackets are fixed into the corresponding accommodating portions facing the same side, and the lighting components on the lighting component bracket face the same direction, so as to obtain the single-side lighting module.

According to a preferred solution of the present invention, the accommodating portions are provided on both sides of the mounting trail along the extending direction of the mounting trail. In such situation, the lighting component brackets are correspondingly fixed into the accommodating portions facing both sides, and the lighting components on the lighting component brackets face two opposite directions, so as to obtain the double-side lighting module. Moreover, this structure reduces the thickness of the whole lighting module to a great extent.

Preferably according to the present invention, the accommodating portions are notches provided in the mounting trail, and the notches provided on both sides of the mounting trail are in a staggered arrangement. The accommodating portions according to the present invention are sunken into the mounting trail, so that a portion between the lighting components is buried into the accommodating portion after the lighting component bracket is mounted into the accommodating portion, thereby the thickness of the whole lighting module is reduced. The thickness of the whole module in the double-side lighting module is further reduced.

According to one solution of the present invention, pluralities of lighting component brackets are electrically connected with each other in series by wires. Since the wires have a relatively light weight, it further reduces the weight of the whole lighting module.

According to a preferred solution of the present invention, the lighting component bracket and the mounting trail are designed into a linear shape, such that the lighting component brackets and the mounting trail are installed into a fishbone structure. The structure of such type has relatively a light weight and is easier for installation.

Another objective of the present invention is accomplished by an illuminating device, especially by a direct backlight illuminating device. The device has the lighting module of at least one of the above types. The whole illuminating device of such type has relatively a light structure weight, and the structure weight will not be notably changed when double-side illumination is realized; moreover, its whole thickness is quite small.

The last objective of the present invention is accomplished by a method for fabricating the lighting module. The method according to the present invention includes the following steps:
a) providing at least one lighting component;
b) fixing the at least one lighting component onto its corresponding lighting component bracket; and
c) mounting the at least one lighting component bracket onto one mounting trail.

In step c) of the method according to the present invention, the lighting component brackets are fixed on one same side of the mounting trail. In such situation, the lighting components on the lighting component brackets face the same direction so as to obtain the single-side lighting module.

Preferably, in step c) of the method according to the present invention, the lighting component brackets are fixed on both sides of the mounting trail. In such situation, the lighting components on the lighting component brackets face two opposite directions so as to obtain the double-side lighting module.

Preferably, the method according to the present invention further includes step d): the plurality of lighting component brackets are electrically connected with each other in series by wires, which realizes the electrical connection between the lighting component brackets in a simple manner and the structure weight is further reduced with the electrical connection by wires.

It should be understood that the general descriptions above and the detailed descriptions below are illustrative, and aim at providing further understanding to the claimed invention.

### BRIEF DESCRIPTION OF THE DRAWINGS

The drawings constitute a portion of the Description for further understanding of the present invention. These drawings illustrate the embodiments of the present invention and explain the principle of the present invention together with the Description. In the drawings, the same element is represented by the same reference sign, wherein

FIG. 1 is a scheme of the lighting module according to the present invention;

FIG. 2 is a scheme of the lighting component bracket for the lighting module according to the present invention;

FIG. 3 is a scheme of the mounting trail for the lighting module according to the present invention; and

FIG. 4 is a scheme of the lighting component brackets being fixed onto the mounting trail according to the present invention.

### DETAILED DESCRIPTION OF THE EMBODIMENTS

FIG. 1 shows the scheme of the lighting module according to the present invention. It can be seen from the figure that the lighting module has a fishbone structure. A plurality of lighting component brackets 2 are sequentially fixed on both sides of the mounting trail 3 with respective lighting component brackets 2 being electrically connected with each other in series by wires 4. In addition, each lighting component bracket 2 is provided with three lighting components 1 (in the present embodiment three LED components are provided thereon), of course, it also can be provided with the lighting component 1 of some other numbers, such as 4, 5 or 6. The lighting components 1 in each lighting component bracket 2 are electrically connected with each other in series. It further can be seen from FIG. 1 that the mounting trail 3 has the end-cap 5 at both ends, respectively, and is fixed onto the shell (not shown) of the illuminating device by the end-caps 5.

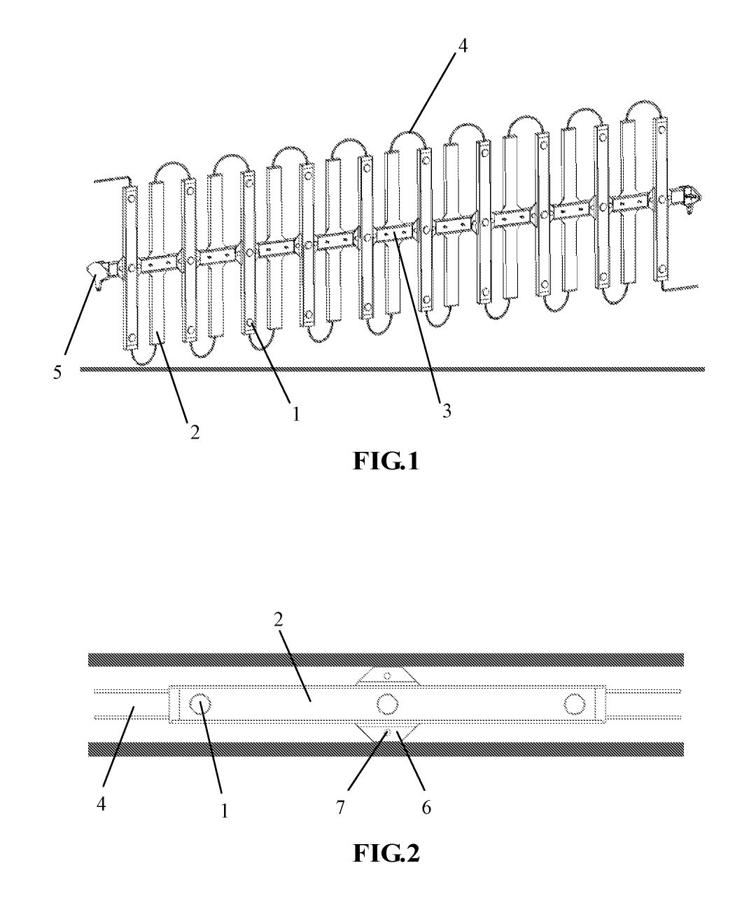

FIG. 2 shows the scheme of the lighting component bracket 2 for the lighting module according to the present invention. Three lighting components 1 on the lighting component bracket 2 are electrically connected with each other in series by the wires 4.

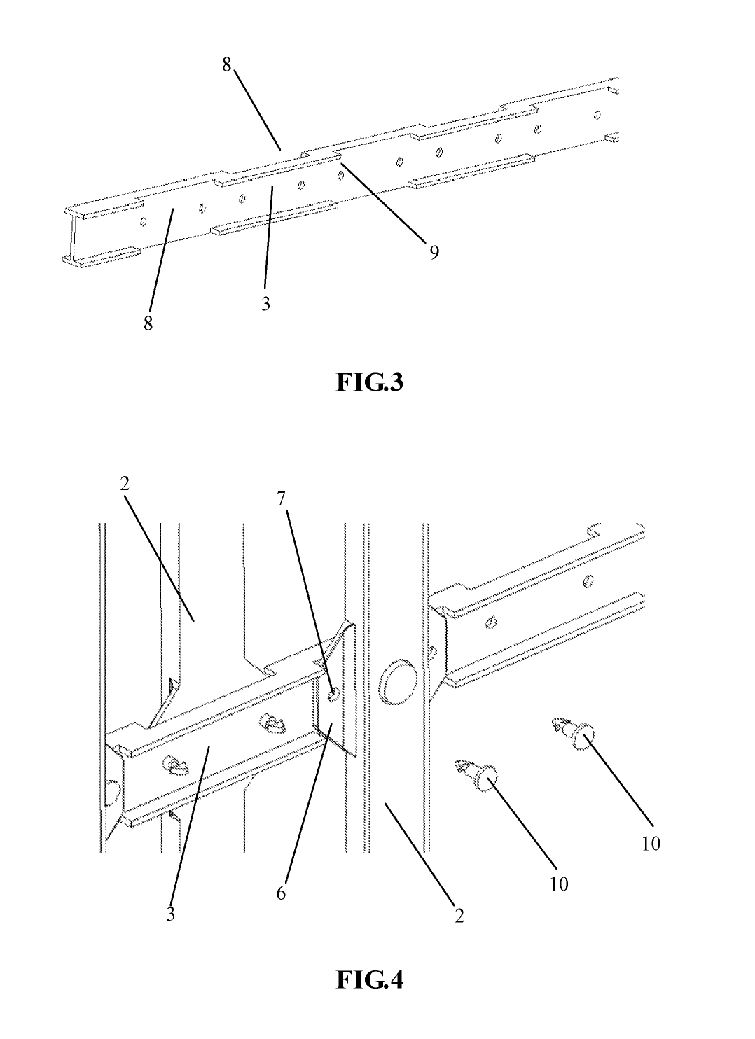

Moreover, it can be seen from FIG. 2 that a mounting lug 6 , provided with throughholes 7, is provided to each of both sides of the middle part of the lighting component bracket 2. The mounting lug 6 is accommodated in the accommodating portion 8 (shown in FIG. 3 in detail) of the mounting trail 3.

FIG. 3 shows the scheme of the mounting trail 3. The mounting trail 3 has on both sides a plurality of accommodating portions 8 for accommodating the mounting lugs 6 of the lighting component brackets 2 shown in FIG. 2. Moreover, the accommodating portions 8 are provided with throughholes 9 corresponding to the throughholes 7 of the mounting lug 6. From the figure it can be seen that the accommodating portions 8 in the form of notch are arranged on both sides of the mounting trail 3.

FIG. 4 shows the scheme of the lighting component brackets 2 being fixed onto the mounting trail 3. It can be seen from the figure that the mounting lug 6 of the lighting component bracket 2 should be inserted into the accommodating portion 8 of the mounting trail 3. Moreover, the fastener 10 such as push screw is inserted into the throughhole 7 and the throughhole 9 subsequently to aligning the throughhole 7 of the mounting lug 6 with the throughhole 9 of the accommodating portion 8 so as to fix the lighting component bracket 2 onto the mounting trail 3. On the left of FIG. 4 shows the lighting component bracket 2 already fixed onto the mounting trail 3, in which the mounting direction of the lighting component bracket 2 is just opposite to that of the lighting component bracket 2 on the right of the figure, so as to realize double-side illumination.

The above is merely preferred embodiments of the present invention but not limiting the present invention. For the person skilled in the art, the present invention may have various alterations and changes. Any alterations, equivalent substitutions, improvements, within the spirit and principle of the present invention, should be covered in the protection scope of the present invention.

### LIST OF REFERENCE SIGNS

1 lighting component (LED component)
2 lighting component bracket
3 mounting trail
4 wire
5 end-cap
6 mounting lug
7 throughhole
8 accommodating portion
9 throughhole
10 fastener (push screw)

1. A lighting module for illuminating device, the lighting module comprising:
at least one lighting component;
at least one lighting component bracket bearing its corresponding lighting component; and
one mounting trail,
wherein each lighting component bracket is mounted onto the mounting trail and fixed onto a shell of the illuminating device by the mounting trail.

2. The lighting module according to claim 1,
wherein the mounting trail has a plurality of accommodating portions, and each lighting component bracket is mounted into its corresponding accommodating portion.

3. The lighting module according to claim 1,
wherein the mounting trail is fixed onto the shell of the illuminating device by end-caps provided at both ends of the mounting trails.

4. The lighting module according to claim 2,
wherein each lighting component bracket is mounted into its corresponding accommodating portion by interference fit with a fastener.

5. The lighting module according to claim 2,
wherein the plurality of accommodating portions are provided on one same side of the mounting trail along an extending direction of the mounting trail.

6. The lighting module according to claim 2,
wherein the plurality of accommodating portions are provided on both sides of the mounting trail, respectively, along an extending direction of the mounting trail.

7. The lighting module according to claim 6,
wherein the accommodating portions are notches provided in the mounting trail, wherein the notches provided on both sides of the mounting trail are in a staggered arrangement.

8. The lighting module according to claim 1,
wherein a plurality of the lighting component brackets are electrically connected with each other in series by wires.

9. The lighting module according to claim 1,
wherein the lighting component bracket and the mounting trail are designed into a linear shape, such that the lighting component bracket and the mounting trail are installed into a fishbone structure.

10. An illuminating device, comprising:
at least one lighting module, comprising:
at least one lighting component;
at least one lighting component bracket bearing its corresponding lighting component; and
one mounting trail,
wherein each lighting component bracket is mounted onto the mounting trail and fixed onto a shell of the illuminating device by the mounting trail.

11. A method for fabricating a lighting module, the method comprising:
a) providing at least one lighting component;
b) fixing the at least one lighting component onto its corresponding lighting component bracket; and
c) mounting the at least one lighting component bracket onto one mounting trail.

12. The method according to claim 11, further comprising:
mounting the lighting component brackets onto one same side of the mounting trail in c).

13. The method according to claim 11, further comprising:
mounting the lighting component brackets onto both sides of the mounting trail in c).

14. The method according to claim 11, further comprising:
electrically connecting a plurality of the lighting component brackets with each other in series by wires.
